(19) United States
(12) Patent Application Publication
(10) Pub. No.: US 2015/0258629 A1
(43) Pub. Date: Sep. 17, 2015

(54) PROCESS FOR WELDING PIPE CONNECTIONS FOR HIGH TEMPERATURE APPLICATIONS

(71) Applicant: ALSTOM Technology Ltd, Baden (CH)

(72) Inventors: Rene RADIS, Zurich (CH); Markus STAUBLI, Dottikon (CH); Roland BUETIKOFER, Endingen (CH)

(21) Appl. No.: 14/657,177

(22) Filed: Mar. 13, 2015

(30) Foreign Application Priority Data
Mar. 14, 2014 (EP) 14159695.7

(51) Int. Cl. B23K 20/227; B23K 20/00; F16L 13/02; B23K 31/02

(52) U.S. Cl. CPC B23K 20/227; B23K 31/02; B23K 20/002; F16L 13/02

(57) ABSTRACT

A process for welding pipe connections for high temperature applications, particularly in power plants, including a first pipe section and a second pipe section. The first pipe section is made of a ferritic material having a first coefficient of thermal expansion. The second pipe section is made of an austenitic material having a second coefficient of thermal expansion, which is different from the first coefficient of thermal expansion. The weld joint is made of an austenitic filler material which has a third coefficient of thermal expansion which is in the range of the second coefficient of thermal expansion. The process includes axially aligning the first and second pipe sections to be connected, making an at least partially V-shaped weld joint open radially inwards, and performing an inside welding process inside the first and second pipe sections to be connected. The invention is further directed to such a pipe connection.

### CROSS-REFERENCE TO RELATED APPLICATIONS

This application claims priority to European application 14159695.7 filed Mar. 14, 2014, the contents of which are hereby incorporated in its entirety.

### TECHNICAL FIELD

The present invention is directed to a process for welding pipe connections for high temperature applications, particularly in power plants, comprising a first pipe section and a second pipe section, wherein the first pipe section is made of a ferritic material having a first coefficient of thermal expansion (CTE1) and wherein the second pipe section is made of an austenitic material having a second coefficient of thermal expansion (CTE2), which is different from the first coefficient of thermal expansion (CTE1), and wherein the weld joint is made of an austenitic filler material which has a third coefficient of thermal expansion (CTE3) which is in the range of the second coefficient of thermal expansion (CTE2). The invention is further directed to such a pipe connection.

### BACKGROUND

In high temperature applications, particularly in power plant applications it is known to use pipe connections (also called intermediate pipe pieces) with a first pipe section made of a ferritic material and a second pipe section made of an austenitic material, wherein the two sections are welded together by using an austenitic filler material. Such a pipe connection which is made from dissimilar metals is also called dissimilar metal weld (DMW). Such DMW pipe connections are usually welded with an at least partially V-shaped welding groove from the outside of the pipe.

DE 195 27 634 A1 describes a pipe connection with such an external weld. In addition it refers to a first pipe section made of ferritic material and a second pipe section made of austenitic material. For welding together both pipe sections a weld filler is used with a thermal expansion coefficient (CTE) which is similar/close to the one of the first ferritic pipe material.

When producing a dissimilar metal weld the problem occurs at the fusion line between the austenitic filler material and the pipe section made of ferritic material that due to the differences in the coefficients of thermal expansion (CTE) the second pipe section made of an austenitic material and the weld joint material (filler material) made of an austenitic material are subject to a higher degree of elongation (ε) than the first pipe section made of ferritic material.

Since the second pipe section and the weld joint filler material are usually having the same coefficient of thermal expansion (CTE) or at least a coefficient of thermal expansion (CTE) in the same range, the connection between the second pipe section and the weld joint material is usually good. However, when DMW pipe connections are subject to high temperatures, there is a big difference in the coefficients of thermal expansion (CTE) between the weld joint material and the first pipe section. This leads to additional stresses due to the differences in elongation (ε). This additional stress is added to stress caused by operating parameters such as pressure inside the pipe connection or as bending moments such that the stress at the critical fusion line is increased and the lifetime of such pipe connections is shortened. It is known that metallurgical properties at the fusion line are responsible for failure of pipe connections after short service times because a hard and brittle martensite layer is formed next to the austenitic phase and a carbon-depleted zone in the ferritic material as well as brittle precipitates at the fusion line are formed.

In order to detect an upcoming failure of a DMW in high temperature piping systems, non-destructive testing (NDT) is therefore regularly performed on such pipe connections in short intervals and the transition piece comprising a dissimilar metal weld (DMW) has to be replaced very often.

It is also known to overcome the problem of reduced lifetime due to additional stress caused by the differences in the coefficients of thermal expansion (CTE) by optimizing the metallurgical properties at the fusion line of the weld joint for example by performing post weld heat treatment (PWHT). Material combinations are known wherein a closer match of the coefficients of thermal expansion (CTE) can be achieved in order to reduce the additional stress. But these approaches are very costly and time consuming.

It is therefore an object of the claimed invention to overcome the disadvantages of the prior art and to provide a process for welding pipe connections and a pipe connection with the goal of minimizing the stress in the area of the DMW when the pipe connection is subject to high temperatures.

### SUMMARY

This object is achieved by providing a process for welding pipe connections for high temperature applications according to the preamble of claim 1. This process comprises the steps of: axially aligning the first and second pipe sections to be connected, making an at least partially V-shaped welding groove open radially inwards, performing an inside welding process inside the first and second pipe sections to be connected. In an inside welding process pipes are welded from the inside diameter rather than from the outside diameter. When the first and second pipe sections are welded together via inside welding by using an at least partially V-shaped welding groove open radially inwards, no additional normal tensile stress is induced on the critical weld joint fusion line between the austenitic filler material and the first pipe section made of ferritic material. When the thermally induced elongation of the austenitic second pipe section and the austenitic filler material occurs, the weld joint material can be supported by the inclined surface of the at least partially V-shaped welding groove which is open radially inwards. Therefore, compressive stress is induced between the weld joint material and the first pipe section such that the lifetime and durability of the dissimilar metal weld connection can be improved.

It is preferred, that a pipe section made of ferritic C-steel is used as the first pipe section. It is particularly preferred that P91 steel or P22 steel is used as ferritic C-steel. Such steels are usually having preferred properties for high temperature applications such as applications in power plants.

Another preferred alternative of the process for welding pipe connections provides that a pipe section made from austenitic steel or from Ni-based materials is used as the second pipe section.

In another preferred alternative of the process austenitic steel or an Ni-based material is used as the austenitic filler material.

The above mentioned object is also achieved by providing a pipe connection according the preamble of claim 6. Such a pipe connection is characterized in that the welding groove is at least partially V-shaped and open radially inwards and that the first and second pipe sections are welded together via inside welding. Because the first and second pipe sections are welded together via inside welding by using an at least partially V-shaped welding groove open radially inwards, no additional normal stress is induced on the critical weld joint fusion line between the austenitic filler material and the first pipe section made of ferritic material. When the thermally induced elongation of the austenitic second pipe section and the austenitic filler material occurs, the weld joint material can be supported by the inclined surface of the at least partially V-shaped welding groove which is open radially inwards because of the inside welding process. Therefore, compressive stress is induced between the weld joint material and the first pipe section such that the lifetime and durability of the dissimilar metal weld connection can be improved by providing a pipe connection according to the invention.

Preferably the welding groove is V-shaped or Y-shaped or is having any other inclined surface of a welding groove opening radially inwards such that the weld joint material can be supported by the inclined surface in order to produce compressive stress when the pipe connection is subject to high temperatures.

In a preferred embodiment of the pipe connection, the first pipe section is made of ferritic C-steel, wherein it is particularly preferred that the ferritic C-steel is P91 steel or P22 steel which are having preferred properties for high temperature power plant applications.

It is particularly preferred that the second pipe section is made of austenitic steel or an Ni-based material.

It is further advantageous that the austenitic filler material is made of austenitic steel or an Ni-based material.

### BRIEF DESCRIPTION OF THE DRAWINGS

FIG. 1 shows a process chart with the steps of a process according to the invention;

FIG. 2 shows a pipe connection according to the state of the art;

FIG. 3 shows a pipe connection according to the invention;

### DETAILED DESCRIPTION

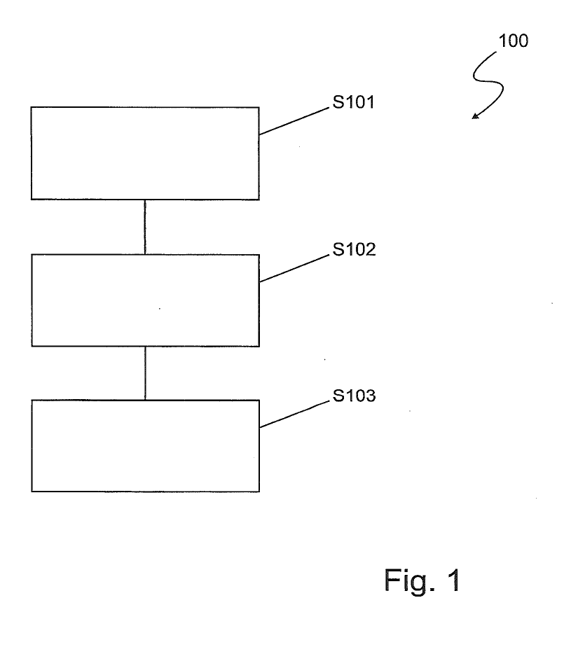

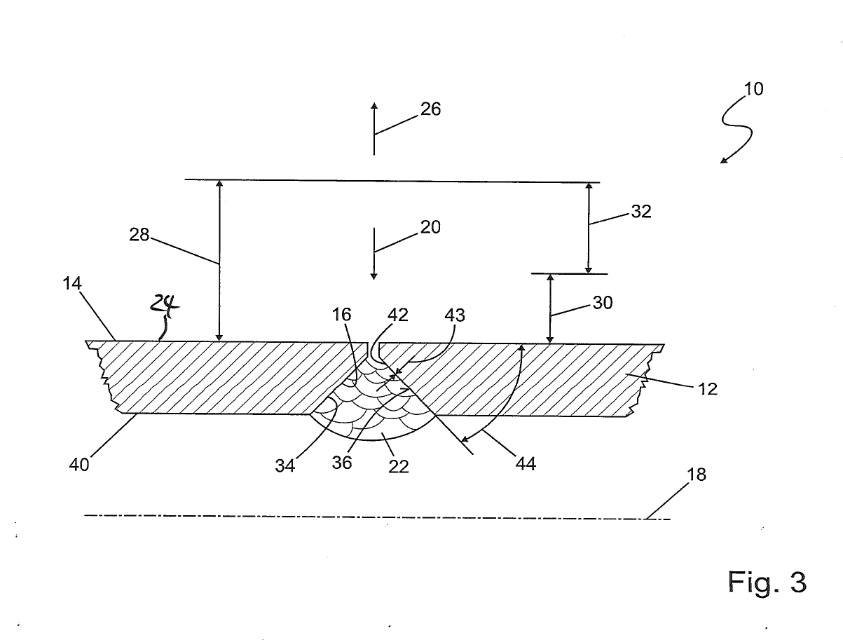

FIG. 1 illustrates a process chart for the process 100 according to the invention for welding pipe connections according to the invention which is shown in FIG. 3. In a first step S101, a first pipe section 12 and a second pipe section 14 of a pipe connection 10 according to the invention are axially aligned in order to be connected.

In a second step S102 an at least partially V-shaped welding groove 16 is formed between the first pipe section 12 and the second pipe section 14 which is open radially inwards that is in the direction of a middle axis 18 shown by arrow 20.

In a third step S103 an inside welding process is performed inside the first and second pipe sections 12, 14 to be connected. In an inside welding process pipes are welded from the inside diameter rather than from the outside diameter. In the process 100 illustrated in FIG. 1, the first pipe section 12 is made of a ferritic material, preferably of P91 or P22 steel (with CTE1 12.6 resp. 13.9 E-6/K) for high temperature applications, wherein the second pipe section 14 is made of an austenitic material, preferably of austenitic steel or an Ni-Based material, for example IN 625 (with CTE2 14.8 E-6/K). A weld joint 22 is made of austenitic weld joint filler material which is preferably austenitic steel or Ni-based material, for example ERNICr-3 (with CTE3 15.3 E-6/K). That means the coefficient of thermal expansion of the weld joint filler material is close (resp. more similar) to the coefficient of thermal expansion of the material of the second pipe section (difference between CTE3 and CTE2 is only 0.5 E-6/K) with respect to the coefficient of thermal expansion of the material of the first pipe section (difference between CTE3 and CTE1 is 2.7 resp. 1.4 E-6/K for the described materials). In another example a first pipe section made of the ferritic base materials P91 (CTE1 12.6 E-6/K) or P22 (CTE1 13.9 E-6/K) is connected to an austenitic pipe section, e.g. SS347H (CTE2 18.9 E-6/K) using a similar filler metal like SS347H with a CTE3 similar to that one of SS347H.

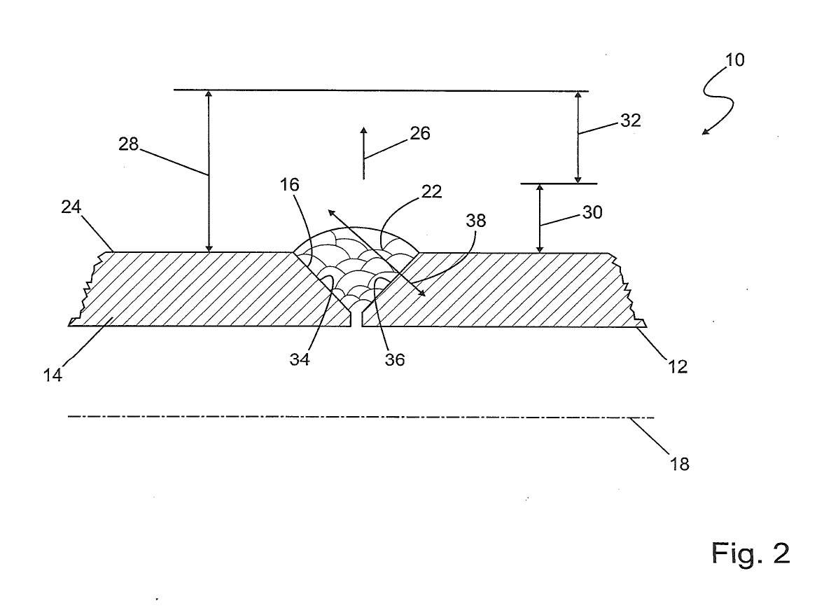

The advantages of the process 100 according to the invention which is illustrated in FIG. 1 and the pipe connection 10 according to the invention which is illustrated in FIG. 3 will now be described in further details with reference to FIGS. 2 and 3.

FIG. 2 is showing a pipe connection 10 according to the state of the art. The same reference numerals will be used for corresponding elements as in the pipe connection 10 according to the invention illustrated in FIG. 3.

The pipe connection 10 is having a first pipe section 12 made of ferritic material and a second pipe section 14 made of austenitic material which are axially aligned around a middle axis 18. A welding groove 16 which is V-shaped is formed on the outside surface 24 of the pipe connection 10 and opens radially outwards in the direction of arrow 26. The welding groove 16 is filled with weld joint filler material of austenitic material which is forming the weld joint 22.

When a pipe connection 10 according to the state of the art is subject to high temperatures such as high temperatures in a power plant, elongations due to different coefficients of thermal expansion (CTE) occur. The second pipe section 14 of austenitic material is having a higher CTE than the first pipe section 12 made of ferritic material. The elongation of the second pipe section 14 is marked by arrow 28, wherein the elongation of the first pipe section 12 is marked by arrow 30. The elongation 28 is bigger than the elongation 30, wherein the delta of the elongations 28, 30 is marked by arrow 32. Because of the choice of materials, the weld joint 22 is providing a good connection at the fusion line 34 between the second pipe section 14 and the weld joint 22 which are both made of austenitic material and having a CTE within the same range, that means they have similar CTE.

However, when the elongations 28, 30 occur because of high temperatures, the already weak connection between the first pipe section 12 and the weld joint 22 in the area of a fusion line 36 is further weakened. Normal stress indicated by arrow 38 is induced on the fusion line 36 between the first pipe section 12 and the weld joint 22. This leads to additional stress which is added to the stress caused by operating parameters such as the inside pressure in the pipe connection 10 or bending moments which act upon the pipe connection 10.

In contrast to the pipe connection 10 according to the state of the art, which is illustrated in FIG. 2, the pipe connection 10 according to the invention, which is shown in FIG. 3, overcomes these problems. The pipe connection 10 is substantially the same as the pipe connection 10 in FIG. 2, because the pipe sections 12, 14 and the weld joint 22 are made of the same material combination as the pipe connection 10 in FIG. 2. However, the welding groove 16, which is filled with weld joint filler material of austenitic material and forming the weld joint 22 is not opening radially outwards. The pipe connection 10 illustrated in FIG. 3 is having a welding groove 16, which is V-shaped and formed on an inside surface 40 of the pipe connection 10 and opening radially inwards in the direction of the middle axis 18 depicted by arrow 20.

When the pipe connection 10 of FIG. 3 is subject to high temperatures the connection between the weld joint 22 and the second pipe section 14 in the area of the fusion line 34 is good because both the second pipe section 14 and the weld joint 22 are made of an austenitic material. However, in the area of the fusion line 36 between the first pipe section 12 of ferritic material and the weld joint 22 a significant improvement can be achieved. When the second pipe section 14 is elongated as depicted by arrow 28 a delta in elongations 32 occurs because the elongation of the first pipe section 12 depicted by arrow 30 is smaller. However, because of the orientation of the welding groove 16 radially inwards, an inclined surface 42 is formed in the area of the fusion line 36. The inclined surface 42 is arranged in an angle 44 to the outside surface 24 of the pipe connection 10. When the weld joint 22 tries to expand in the direction of arrow 26, the movement is restricted by the inclined surface 42 which is exerting a counterforce on the weld joint 22. Thus, inside welding of a pipe connection 10 according to FIG. 3 by performing the process 100 illustrated in FIG. 1 and by providing a V-shaped welding groove 16 open radially inwards leads to reduced stress in the area of the weld joint 22. Compressive stress is induced on the fusion line 36 as depicted by arrow 43. Therefore, the operation time of pipe connections 10 according to the invention and shown in FIG. 3 can be significantly enhanced whereas high costs for inspection of the pipe connection 10 via non-destructive testing (NDT) or other high costs in order to improve the stress levels at the weld joint 22 can be avoided.

1. A process for welding pipe connections for high temperature applications, particularly in power plants, having a first pipe section and a second pipe section, wherein the first pipe section is made of a ferritic material having a first coefficient of thermal expansion and wherein the second pipe section is made of an austenitic material having a second coefficient of thermal expansion, which is different from the first coefficient of thermal expansion, and wherein the weld joint is made of an austenitic filler material which has a third coefficient of thermal expansion which is close to the second coefficient of thermal expansion; the process:
axially aligning the first and second pipe sections to be connected making an at least partially V-shaped welding groove open radially inwards; and
performing an inside welding process inside the first and second pipe sections to be connected.

2. The process for welding according to claim 1, wherein a pipe section made of ferritic C-steel is used as the first pipe section.

3. The process for welding according to claim 2, wherein P91 steel or P22 steel is used as ferritic C-steel.

4. The process for welding according to claim 1, wherein a pipe section made from austenitic steel or from Ni-based materials is used as the second pipe section.

5. The process for welding according to claim 1, wherein austenitic steel or a Ni-based material is used as the austenitic filler material.

6. A pipe connection for high temperature applications, particularly in power plants; the pipe comprising a first pipe section and a second pipe section, wherein the first pipe section is made of a ferritic material having a first coefficient of thermal expansion and wherein the second pipe section is made of an austenitic material having a second coefficient of thermal expansion, which is different from the first coefficient of thermal expansion , wherein the weld joint is made of an austenitic filler material which has a third coefficient of thermal expansion which is in the range of the second coefficient of thermal expansion, and wherein the welding groove is at least partially V-shaped and open radially inwards and that the first and second pipe sections are welded together via inside welding.

7. The pipe connection according to claim 6, wherein the first pipe section is made of ferritic C-steel.

8. The pipe connection according to claim 7, wherein the ferritic C-steel is P91 steel or P22 steel.

9. The pipe connection according to claim 6, wherein the second pipe section is made of austenitic steel or a Ni-based material.

10. The pipe connection according to claim 6, wherein the austenitic filler material is made of austenitic steel or a Ni-based material.
